(19) United States
(12) Patent Application Publication
(10) Pub. No.: US 2024/0303682 A1
(43) Pub. Date: Sep. 12, 2024

(54) INFORMATION PROCESSING SYSTEM, COMPENSATION DETERMINATION METHOD, AND COMPUTER-READABLE RECORDING MEDIUM STORING CONTROL PROGRAM

(71) Applicant: Konica Minolta, Inc., Tokyo (JP)

(72) Inventors: Takahiro KUSUNOKI, Tokyo (JP); Toshiaki MIYAKI, Yokohama-shi (JP); Takashi FUJIWARA, Tokyo (JP); Masahiro YAMAGUCHI, Tokyo (JP); Toshiyuki TSUKAHARA, Yokohama-shi (JP)

(73) Assignee: Konica Minolta, Inc., Tokyo (JP)

(21) Appl. No.: 18/425,578

(22) Filed: Jan. 29, 2024

(30) Foreign Application Priority Data
Mar. 9, 2023 (JP) 2023-036441

(51) Int. Cl. G06Q 30/0208; G06Q 30/0241; G06Q 30/0242

(52) U.S. Cl. CPC G06Q 30/0208; G06Q 30/0242; G06Q 30/0276

(57) ABSTRACT

An information processing system includes: an acquirer that acquires first information relating to an advertising effect of a product created by an image forming apparatus; a first determiner that determines, based on the first information, first compensation information relating to compensation to be paid by a product user that requests the creation of the product to a first provider that creates the product by the image forming apparatus; and a second determiner that determines, based on the first information, second compensation information relating to compensation to be paid by the first provider to a second provider that provides a consumable to be used in the image forming apparatus.

### CROSS-REFERENCE TO RELATED APPLICATION

The entire disclosure of Japanese patent application No. 2023-036441, filed on Mar. 9, 2023, is incorporated herein by reference in its entirety.

### BACKGROUND OF THE INVENTION

### 1. Technical Field

The present invention relates to an information processing system, a compensation determination method, and a control program.

### 2. Description of Related Art

Conventionally, a brand owner that wants to promote merchandise or the like causes creation of a product for the purpose of promoting the merchandise, and sends the product to consumers by direct messages or distributes the product at an exhibition hall. However, it is difficult to grasp the degree of the advertising effect of the product only by distributing the product.

According to a method disclosed in Japanese Unexamined Patent Application Publication No. 2004-185302, a number code and a confirmation code are given to a product to be supplied to a user, the product to which the number code and the confirmation code are given is supplied to the user, a server collates the number code input together with a user code with registered winning information via an input means of a personal computer connected to the Internet, gives points according to a collation result, and pools the points for each user. Thus, the product is prevented from being discarded without being viewed.

### SUMMARY OF THE INVENTION

However, in the method disclosed in Japanese Unexamined Patent Application Publication No. 2004-185302, the advertising effect of the product is unknown at the time of creation of the product. Even in a case where the advertising effect is not as expected, the brand owner requires a certain cost to create the product. This becomes a barrier, and the brand owner may hesitate to create a product as an advertisement medium for promoting and advertising merchandise. In addition, since the advertising effect of the product is unknown at the time of contracting, even if a printing company contracting to creation of the product creates the product having the advertising effect, the advertising effect is not reflected in compensation for the product (the price cannot be set aggressively), which does not lead to the motivation to create the product having the advertising effect. As described above, both the brand owner as a product user and the printing company as a contractor have a weak motivation to actively use a product for advertising merchandise, and tend to be discouraged.

The present invention has been made in view of the above-described circumstances, and an object of the present invention is to remove such a barrier and activate the market for promotion and advertisement of merchandise using a product.

To achieve at least one of the abovementioned objects, according to an aspect of the present invention, a system reflecting one aspect of the present inventions comprises the followings.

An information processing system including:

an acquirer that acquires first information relating to an advertising effect of a product created by an image forming apparatus;

a first determiner that determines, based on the first information, first compensation information relating to compensation to be paid by a product user that requests the creation of the product to a first provider that creates the product by the image forming apparatus; and

a second determiner that determines, based on the first information, second compensation information relating to compensation to be paid by the first provider to a second provider that provides a consumable to be used in the image forming apparatus.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic diagram illustrating a situation in which a product, an advertisement, payment of compensation, and the like are handled in a market to which an information processing system according to a first embodiment is applied;

FIG. 2 illustrates an example of a product for advertising to which a two-dimensional code obtained by encoding a URL of a web page is attached as information for advertising effect measurement;

FIG. 3 is a diagram illustrating a relationship between various kinds of information for advertising effect measurement and index values used to determine an advertising effect;

FIG. 4 is a block diagram illustrating a schematic configuration of the information processing system;

FIG. 5 is a diagram illustrating results of comparison with a reference x1 and changes in and maintenance of first and second compensation information in a method 2;

FIG. 6 is a diagram illustrating examples of a reference for various advertising effects;

FIG. 7 is a flowchart illustrating a process of determining compensation based on an advertising effect;

FIG. 8 is an example of a setting table 4 in which first and second compensation information are changed according to an advertising effect;

FIG. 9 is a schematic diagram illustrating a situation in which a product, an advertisement, payment of compensation, and the like are handled in a market to which an information processing system according to a second embodiment is applied; and

FIG. 10 is a flowchart illustrating a process of determining compensation based on an advertising effect and a unit price per print (first compensation information).

### DETAILED DESCRIPTION

In the following, embodiments of the present invention will be described with reference to the accompanying drawings. However, the scope of the present invention is not limited to the disclosed embodiments. Note that in the description of the drawings, the same components are denoted by the same reference signs, and redundant descriptions are omitted. In addition, dimensional ratios in the drawings are exaggerated for convenience of description and may be different from actual ratios.

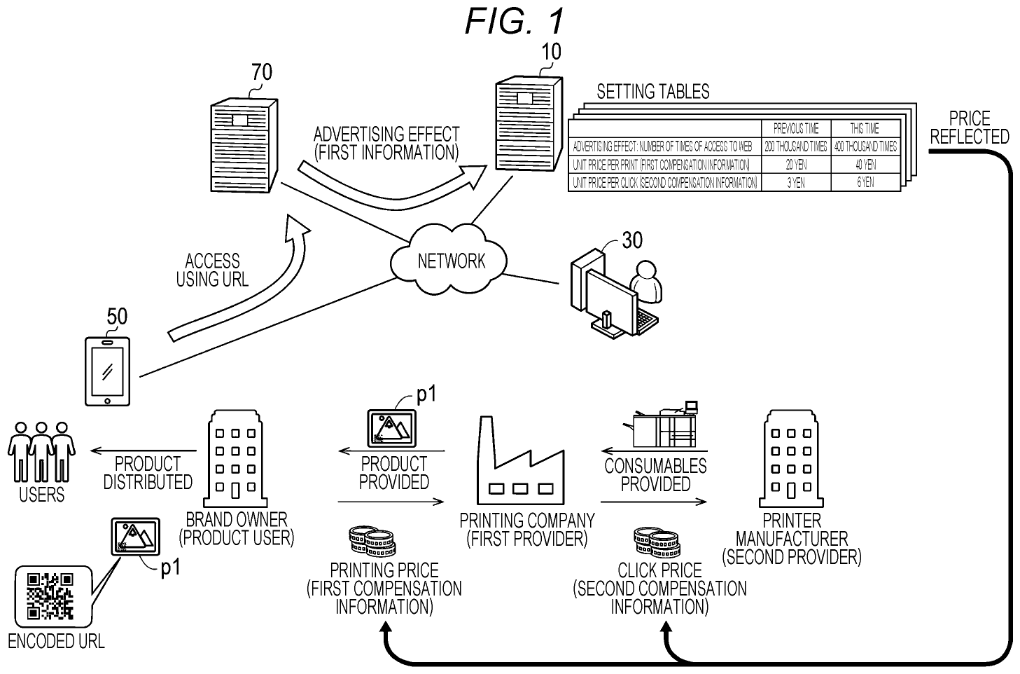

FIG. 1 is a schematic diagram illustrating a situation in which a product, an advertisement, payment of compensation, and the like are handled in a market to which an information processing system 10 according to a first embodiment is applied.

As illustrated in FIG. 1, the information processing system 10 is communicably connected to terminal devices 30 and 50, a web server 70, and the like via a network. The network is a communication line such as a public telephone network or a data communication network. In some networks, wired LANs, wireless LANs, and the like (for example, LANs conforming to the IEEE802.11 standard) may be used.

The terminal devices 30 and 50 are personal computers (PCs) or portable communication terminals such as smartphones. For example, the terminal device 30 is a PC used by a user of the information processing system 10, and the terminal device 50 is a smartphone with a camera function used by the user. The user is also referred to as a customer or a consumer, and purchases merchandise or uses a service provided by a brand owner. The brand owner is a business operator that sells merchandise to users or provides services such as seminars, training, and events (hereinafter, these are referred to as seminars or the like) to the users.

The brand owner is an advertiser, and distributes (hands over, sends a direct mail (DM)) a product for advertising to the users in order to advertise merchandise or service (hereinafter, referred to as merchandise or the like) to the users.

A printing company creates a product p1 in response to a request from a customer such as the brand owner and provides the customer with the product. For example, one hundred to several hundred thousand products p1 are created in one lot (which refers to an order unit, the same applies hereinafter). The product p1 is, for example, promotion paper printed on a cut sheet or a poster printed on a large-size sheet. An image forming apparatus used by the printing company includes an analog printing machine which performs mass printing by creating a plate for an offset printing method or the like, and a digital printing machine using a method such as an electrophotographic method or an inkjet method.

A printing machine manufacturer provides the digital printing machine to the printing company, and also provides consumables of the digital printing machine to the printing company. In a case where the digital printing machine is a digital printing machine that uses an electrophotographic method, the consumables include toner. In a case where the digital printing machine is an inkjet digital printing machine, the consumables include ink.

In a procedure of creating and providing the product p1 illustrated in FIG. 1, the brand owner is a product user. The printing company is a first provider that provides the product to the brand owner in response to a request from the brand owner. The printing machine manufacturer is a second provider that provides the printing machine itself or supplies consumables for the product p1 in response to a request or a contract of the printing company.

The brand owner as the product user pays compensation corresponding to a printing price to the printing company as the first provider in return for the provision of the product p1. The printing price is calculated based on first compensation information. In this case, each piece of compensation information (first and second compensation information) includes information used for calculation of compensation to be paid, information serving as an indicator for determination of the compensation, and the like. For example, the compensation information is a unit price (unit price for sheet) per printed sheet. In this case, the printing price is calculated by multiplying the first compensation information by the number of printed sheets. The compensation information may be a stepwise flat rate according to the number of printed sheets of one contracted lot.

The printing company, which is the first provider, pays compensation corresponding to a click price to the printing machine manufacturer, which is the second provider, in return for providing a consumable of the printing machine used to create the product. Here, the click price is a price corresponding to the consumed amount (replenished amount) of the consumable or a price corresponding to the number of printed sheets, and is calculated based on the second compensation information and the consumed amount or the number of printed sheets.

In the present embodiment, the brand owner, the printing company, and the printing machine manufacturer, that is, the three parties that are the product user and the first and second providers cooperate as a whole to carry out a procedure of creating and providing the product p1. Then, the first and second compensation information are determined by the information processing system 10 (first and second determiners) in conjunction with each other based on the same index value (hereinafter, also referred to as first information) relating to an advertising effect as will be described later. There may be three administrators of the information processing system 10. In this case, the management of the information processing system 10 is performed jointly by the three parties. As another example, the management may be performed by any one of the three parties. For example, the printing machine manufacturer manages and operates the information processing system 10 as a main entity. In addition, an administrator sets numerical values of a setting table for determining the first and second compensation information in accordance with a contract with the other two parties or adjustment or agreement of the three parties in advance. In addition, the administrator selects a setting table to be applied from among a plurality of setting tables (setting tables 1 to n to be described later) in which different preset numerical values are described, according to the contract with the other two parties or adjustment or agreement of the three parties in advance.

Each of the first and second compensation information is, for example, a unit price per printed sheet (also referred to as a unit price per sheet), and by multiplying this unit price by the number of printed sheets, the compensation (printing price, click price) is calculated. Alternatively, each of the first and second compensation information may be a stepwise flat rate according to the number of printed sheets of one contracted lot.

### Index Value (First Information) Relating to Advertising Effect

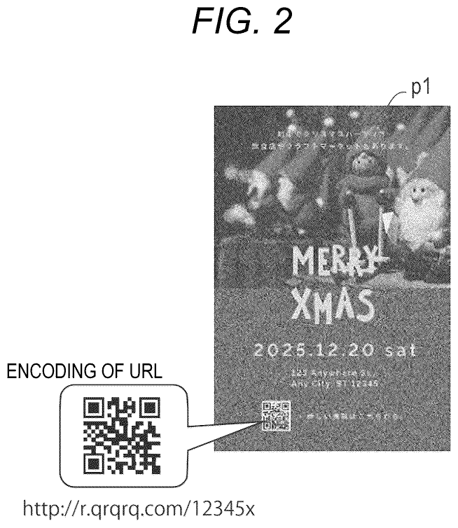

FIG. 2 illustrates an example of the product p1 for advertisement to which a two-dimensional code obtained by encoding a uniform resource locator (URL) of a web page is attached (printed) as information (hereinafter, also simply referred to as print information) for advertising effect measurement. The brand owner receives the product p1 from the printing company and distributes the product p1 to the users. The users can access the web page specified by the URL via the two-dimensional code attached to the product p1. For example, the terminal device 50 reads the two-dimensional code with the camera function, decodes the two-dimensional code to obtain the URL, and accesses the web server 70 using the URL to obtain the web page. This web page is a web page for merchandise purchase or a web page showing detailed information of the merchandise in a case where the product for advertisement relates to merchandise purchase. Alternatively, in a case where the product for advertisement relates to a service such as a seminar or training, the web page is a web page for application of the seminar or the training or is a web page showing detailed information of the service.

A two-dimensional code of the same URL is printed on products (for example, 100,000 sheets) of one lot. In addition, products p1 of a plurality of lots may be created in order to provide, at different times, products of the same content or substantially the same products in which the same merchandise or the like is an advertisement target. In this case, a two-dimensional code of a different URL may be given to a product p1 for each lot.

The web server 70 may be a web server managed by the brand owner himself/herself or a web server managed by a client to which the brand owner outsources the management. When the web server 70 is accessed by a user via the two-dimensional code attached to the product p1, the web server 70 counts the number of times of access. Information of the count number is provided to the information processing system 10 as an index value (first information) relating to the advertising effect. The information processing system 10 that has acquired the index value relating to the advertising effect changes the first and second compensation information by using the index value. Thus, the compensation (printing price) that the product user pays to the first provider and the compensation (click price) that the first provider pays to the second provider are determined.

### Another Index Value Relating to Advertising Effect

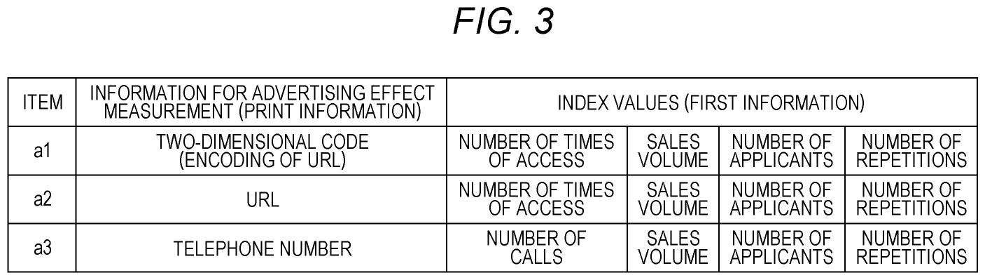

In the example illustrated in FIG. 2, the print information for advertising effect measurement given to the product is the two-dimensional code of the URL, and the index value is the number of times of access to the web page by the URL, but the present invention is not limited thereto, and the print information and the index value may be print information and an index value illustrated in FIG. 3.

Print information of an item a1 in FIG. 3 is the two-dimensional code of the URL illustrated in FIG. 2. An index value relating to the item a1 is as follows.
The number of times of access to this URL
A sales volume (sales quantity, total sales amount) of merchandise on a merchandise purchase screen displayed via the URL
The number of applicants on an application screen for a seminar or the like displayed via the URL, or
The number of repetitions by the same user for merchandise purchase or application for the seminar or the like.

Print information of an item a2 in FIG. 3 is obtained by printing the URL itself. An index value relating to the item a2 is equal to that in the item a1. A user that has acquired the product p1 can access the web page by inputting the URL to the terminal device.

Print information in the item a3 in FIG. 3 is a telephone number. An index value relating to the item a3 is not the number of times of access but the number of calls, but the others in the item a3 are the same as those in the items a1 and a2. These index values may be automatically measured by the web server 70 and sent to the information processing system 10. Alternatively, the administrator (which may be any of the product user and the first and second providers) of the information processing system 10 may aggregate the index values and input the index values from the terminal device 30 to transmit the index values to the information processing system 10.

### Determination of First and Second Compensation Information by Information Processing System 10

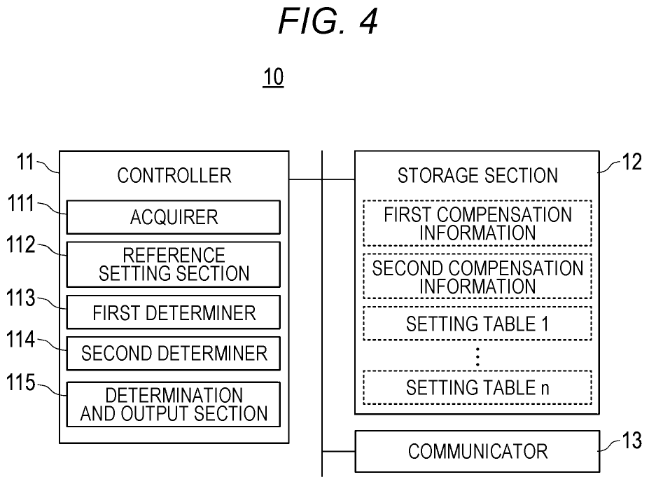

FIG. 4 is a block diagram illustrating a schematic configuration of the information processing system 10. The information processing system 10 includes a controller 11, a storage section 12, and a communicator 13. The information processing system 10 may be, for example, an on-premise server located on the premises of any of the companies of the product user, the first provider, and the second provider, or may be a cloud server using a commercial cloud service.

### Controller 11

The controller 11 includes a CPU and memories such as a RAM and a ROM. The CPU is a control circuit constituted by a multi-core processor or the like that executes control of the above-described sections and various kinds of arithmetic processing in accordance with a program. Each function of the information processing system 10 is implemented by the CPU executing a program corresponding to the function. Furthermore, the controller 11 functions as an acquirer 111 by cooperating with the communicator 13. The controller 11 functions as a reference setting section 112, a first determiner 113, a second determiner 114, and a determination and output section 115.

The storage section 12 is a large-capacity auxiliary storage device that stores various programs including an operating system and various types of data. As the storage, for example, a hard disk, a solid state drive, a flash memory, a ROM, or the like is used. The storage section 12 stores the first and second compensation information and the plurality of setting tables 1 to n. These setting tables are provided for respective combinations of the items a1 to a3, a method 1 or a method 2 (methods c21 to c23), and items d1 to d4 in FIGS. 3, 5, 6, and the like described later.

### Communicator 13

The communicator 13 is also an interface for network connection to an external device such as a PC.

### Acquirer 111

The acquirer 111 acquires an index value to be used for determination of the advertising effect of the web server 70. For example, the acquirer 111 acquires, from the web server 70, the number of times of access, a sales volume, the number of participants, and/or the number of repetitions via the URL. In addition, the acquirer 111 acquires the number of times of access, the sales volume, the number of participants, and/or the number of repetitions via the URL through the terminal device 30.

### Reference Setting Section 112

The reference setting section 112 sets a reference x1 for the advertising effect. The reference setting section 112 sets the reference x1 for the advertising effect according to advertisement content printed on the product p1, the business size of the product user (brand owner), the sales volume of merchandise, the type of the merchandise, whether or not the merchandise is a seasonal-related merchandise, advertisement means, and the like. A specific example of the setting of the reference x1 will be described later.

### First and Second Determiners 113 and 114

The first determiner 113 determines the first compensation information based on the first information (index value) relating to the effect of the product. The first compensation information relates to information of compensation that the product user (brand owner) that requests to create the product pays to the first provider (printing company) that creates the product by using the image forming apparatus (digital printing machine). In addition, the second determiner 114 determines, based on the same first information (index value), the second compensation information relating to information of compensation to be paid by the first provider to the second provider (printing machine manufacturer) that provides a consumable to be used in the image forming apparatus. In this case, the first compensation information is also information relating to the calculation of the compensation to be paid to the first provider. Further, the second compensation information is also information relating to the calculation of the compensation to be paid to the second provider.

### Determination and Output Section 115

The determination and output section 115 functions as a determiner and an output section. The determination and output section 115 determines, based on second information acquired by the acquirer 111 and relating to the advertisement, whether or not to create the product by the image forming apparatus as a product of which the advertising effect of the advertisement can be measured. That is, the determination and output section 115 determines whether or not to add print information for the advertising effect measurement to the product p1. Further, the determination and output section 115 outputs a result of the determination. The second information relating to the advertisement is, for example, information relating to a distribution target person to which the advertisement is to be distributed, or information relating to merchandise or a service that is an advertisement target. For example, in a case where the target of the advertisement is merchandise or a service, the determination and output section 115 performs the determination according to the number of times of use (the number of times of purchase or the number of times of provision) by the distribution target person. In this case, the determination and output section 115 performs the determination according to the number of days elapsed after the previous purchase of the merchandise or the last provision of the service. When the number of times of use is equal to or less than a predetermined value or when the number of elapsed days is shorter than a predetermined period, the determination and output section 115 determines to create a product of which an advertising effect can be measured. Alternatively, when the price of the merchandise is higher than a predetermined amount of money or when the service is “subscription”, the determination and output section 115 determines to create the product of which the advertising effect can be measured. The output result is display data and is transmitted, for example, from the information processing system 10 to a PC or the like located in the printing company and is displayed by the PC or the like.

### Method 1

Specifically, as the method 1, the first determiner 113 determines the first compensation information by using the index value acquired by the acquirer 111 and the setting table 1. The relationship between the index value and the first compensation information is described in the setting table 1. Similarly, the second determiner 114 determines the second compensation information by using the same index value acquired by the acquirer 111 and the setting table 2. The relationship between the index value and the second compensation information is described in the setting table 2. Note that the setting table 1 may store a plurality of tables having different values. The administrator (for example, the first provider) may select a desired setting table 1 from among the tables of the setting table 1 according to a contract with another party (for example, a party other than the first provider). Similarly, a plurality of tables having different values may be stored in the setting table 2. In addition, the administrator may select a desired setting table 1 from among the setting tables in accordance with a contract with another party (for example, a party other than the first provider) (the same applies to the other setting tables 3, 4, . . . , and n which will be described later).

### Method 2

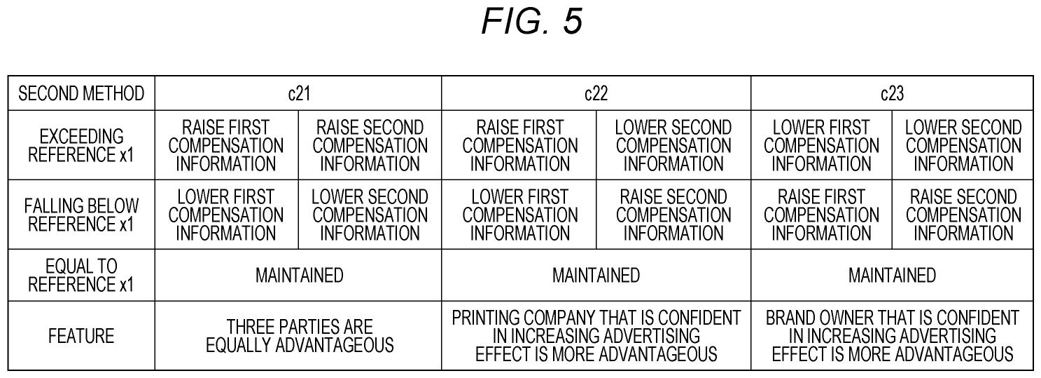

Alternatively, as the method 2, the first and second determiners 113 and 114 may compare the index value acquired by the acquirer 111 with the reference x1, and change or maintain the first and second compensation information according to results of the comparison. FIG. 5 is a diagram illustrating the results of the comparison with the reference x1 and changes in and maintenance of the first and second compensation information in the method 2. In the method 2, any of the methods c21, c22, and c23 can be applied.

### Method c21

As illustrated in FIG. 5, for example, in the method c21, when the index value (first information) of the advertising effect exceeds the reference x1, the first determiner 113 raises the first compensation information to be higher than default compensation information. That is, compensation to be paid from the product user to the first provider is increased. For example, when the number of times of access to the web page by the URL as the index value is 20,000 times and exceeds 10,000 times as the reference x1, the first determiner 113 raises the first compensation information. Similarly, when the index value of the advertising effect exceeds the reference x1, the second determiner 114 raises the second compensation information to be higher than the default compensation information. That is, the compensation to be paid from the first provider to the second provider is increased. On the other hand, when the index value of the advertising effect falls below the reference x1, the first and second determiners 113 and 114 lower the first and second compensation information, respectively. In addition, when the index value of the advertising effect is equal to the reference x1, the default compensation information is maintained as the first and second compensation information. Note that the first and second determiners 113 and 114 may determine with a certain margin whether the index value of the advertising effect is equal to or higher or lower than the reference x1 (the same applies to the following methods c22 and c23). For example, a case is considered where the reference x1 is 10,000 times, and the index value is in a range of values that differ from the reference x1 by several % of the reference x1 (for example, 9,000 to 11,000 times in a range of ±10% of the reference x1). In this case, assuming that there is no significant difference, the first and second determiners 113 and 114 determine that the index value of the advertising effect is equal to (equivalent to) the reference x1, and when the index value is out of the range, the first and second determines 113 and 114 determine that the index value is higher or lower than the reference x1.

### Method c22

As illustrated in FIG. 5, in the method c22, when the index value of the advertising effect exceeds the reference x1, the first determiner 113 raises the first compensation information. Similarly, when the index value of the advertising effect exceeds the reference x1, the second determiner 114 lowers the second compensation information, that is, decreases the compensation to be paid from the first provider to the second provider. When the index value of the advertising effect falls below the reference x1, the first and second determiners 113 and 114 perform processing opposite to the above-described processing as illustrated in FIG. 5. As illustrated in FIG. 5, in the method c22, the printing company (first provider) that is confident in increasing the advertising effect is more advantageous. This method c22 is preferably applied, for example, when the first provider operates the information processing system 10 as a main entity.

### Method c23

As illustrated in FIG. 5, in the method c23, the first and second determiners 113 and 114 perform processing in a direction opposite to that in the method c21. That is, when the index value exceeds the reference x1, the first and second compensation information are lowered, and when the index value falls below the reference x1, the first and second compensation information are raised. As illustrated in FIG. 5, in the method c23, the brand owner (product user) that is confident in increasing the advertising effect is more advantageous. The method c23 is preferably applied, for example, when the product user operates the information processing system 10 as a main entity.

### Timing

Note that the acquisition of the index value and the timing of determining the compensation information will be described as items common to the first and second methods.

As a first example, the acquisition of the index value is started immediately after the product p1 is created (or after the distribution of the product p1 from the product user to a user is started), and is ended before a predetermined ending period elapses. The ending period is several weeks to several months, for example, one month, from the end of the creation of the product p1. For example, in the case of the number of times of access to the web page of the URL, the acquirer 111 acquires, as the index value, the total number of times of access until a time point when one month has elapsed. Then, the first and second determiners 113 and 114 determine the first and second compensation information based on the index value. The payment of the compensation between the product user and the first provider and between the first provider and the second provider is made at the printing price and the click price calculated based on the determined first and second compensation information.

As a second example, there may be a contract in which delivery of products of a plurality of lots is repeatedly performed. In this case, for the first lot, compensation is paid in a predetermined amount of money. Then, in the second and subsequent lots, based on an index value in an immediately preceding lot n−1, first and second compensation information for the next lot n are determined, and reflected in creating a product p1 in the next lot n. For example, in the second lot, the compensation is determined based on the first and second compensation information determined based on the index value in the first lot.

### Setting of Reference x1

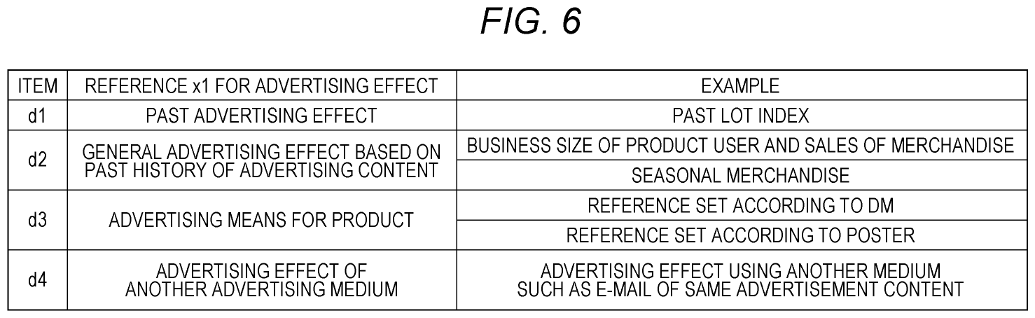

FIG. 6 is a diagram illustrating examples of a reference x1 for various advertising effects. The reference setting section 112 can set the reference x1 using any of the items d1 to d4. For example, it is assumed that the item d1 is used. When a product p1 on which the same advertisement content as advertisement content printed on a product p1 in the past is printed is to be created, the reference setting section 112 sets an advertising effect of the product in the past as the reference for the advertising effect. For example, when printing of substantially the same advertisement content (merchandise or the like is the same) is continuously performed on a plurality of lots, the reference setting section 112 sets the index value of the advertising effect in the past lot to the reference x1. For example, when the number of times of access as the index value in the immediately preceding lot is 100,000 times, the reference setting section 112 sets 100,000 times as the reference x1.

When the item d2 is used, the reference setting section 112 sets the reference x1 based on a general advertising effect according to a past history of the advertisement content. For example, the reference x1 is set according to the business size of the product user, the sales of merchandise to be advertised, or whether or not the merchandise is seasonal merchandise such as a bon festival gift, a year-end gift, or a Christmas gift. The relationship between the advertisement content and the reference x1 is set in the setting table 3.

When the item d3 is used, the reference setting section 112 sets the reference x1 according to whether advertisement means for the product p1 is a DM or a poster. For example, it is empirically found that 5% of users respond to the number of printed sheets of the product p1 (the number of distributed sheets) on average, and thus the reference x1 can be calculated by multiplying the number of printed sheets of a lot of the product p1 by 5%. The relationship between the advertisement means and the reference x1 is set in the setting table 4.

In a case where the item d4 is used, when the same advertisement content is provided on another medium, the reference setting section 112 sets the reference x1 with reference to an advertising effect of the other advertisement medium. For example, when the product user has transmitted the same advertisement content to a user by e-mail as the other advertisement medium, the reference setting section 112 sets the reference x1 based on the number of responses to the e-mail. In the case of the item d4, the administrator may input the reference x1 via the terminal device 30, and the reference setting section 112 may acquire the reference x1.

### Process of Determining Compensation Based on Advertising Effect

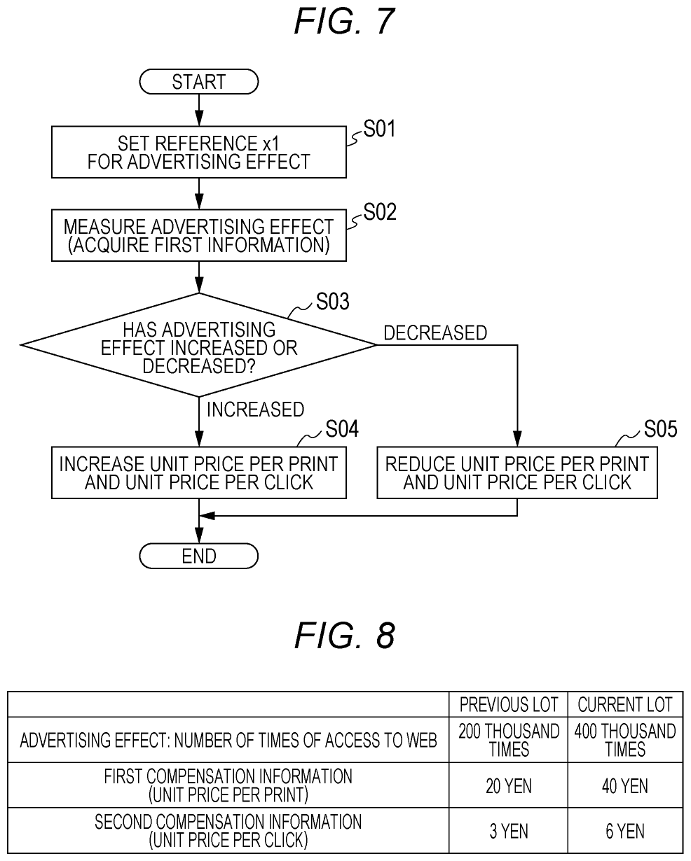

Next, with reference to FIGS. 7 and 8, a process of determining compensation based on an advertising effect will be described. FIG. 7 is a flowchart illustrating the compensation determination process executed by the information processing system 10. The following description will be given taking, as an example, a case where the item a1 (the number of times of access using a two-dimensional code), the method c21 of the method 2, and the item d1 (past advertising effect) are used in FIGS. 3, 5, and 6 described above. Before this process, the product p1 of the current lot has already been created and distributed to a user.

### Step S01

The reference setting section 112 sets a reference x1 for the advertising effect. For example, when the number of times of access to the web server 70 in a past lot is 200,000 times, the reference setting section 112 sets the reference x1 to 200,000 times. More specifically, the number of times of access in this case is the number of times of access to the web page to which the URL specified by the print information is linked (the same applies hereinafter).

### Step S02

The acquirer 111 acquires the first information (index value) as a result of measuring the advertising effect. For example, the controller 11 acquires the number of times of access to the web server 70 until a time point when a predetermined period has elapsed since the product p1 was created, for example, until a time point when one month has elapsed.

### Step S03

The controller 11 compares the first information with the reference x1, and when the first information exceeds the reference x1 (or is raised), the controller 11 advances the process to step S04. On the other hand, when the first information falls below the reference x1 (or is lowered), the controller 11 advances the process to step S05.

### Step S04

In this case, the first and second determiners 113 and 114 raise the first and second compensation information, respectively. Thus, a unit price per print and a unit price per click increase. FIG. 8 illustrates an example of the setting table 4. For example, since the number of times of access is 400,000 times in the current lot, and exceeds the previous number of times of access, which is 200,000 times (reference x1), the unit price per print and the unit price per click are increased by a factor of 2.

### Step S05

In this case, the first and second determiners 113 and 114 lower the first and second compensation information, respectively. Thus, the unit price per print and the unit price per click decrease.

As described above, the information processing system according to the present embodiment includes: the acquirer that acquires first information relating to an advertising effect of a product created by the image forming apparatus; the first determiner that determines, based on the first information, first compensation information relating to compensation to be paid by the product user that requests the creation of the product to the first provider that creates the product by the image forming apparatus; and the second determiner that determines, based on the first information, second compensation information relating to compensation to be paid by the first provider to the second provider that provides a consumable to be used in the image forming apparatus.

As a result, the product user and the printing company actively use the promotion and advertisement of the merchandise using the product, and the market is activated. In particular, the brand owner that is the product user will pay the compensation corresponding to the advertising effect to the printing company, thus making it easier to request creation of a product such as a DM. Furthermore, the printing company can also receive the compensation corresponding to the advertising effect and can receive fixed compensation even when the advertising effect is low. The printing machine manufacturer that supplies consumables and the like can also reflect the compensation received by the printing company in the prices of the consumables. In this case, the promotion and advertisement of the merchandise or the like by the product is activated, thus the number of printed sheets increases, and as a result, it is possible to receive a merit due to an increase in demand for consumables. That is, both the product user and the first and second providers can avoid the risk and receive the merit.

### Second Embodiment

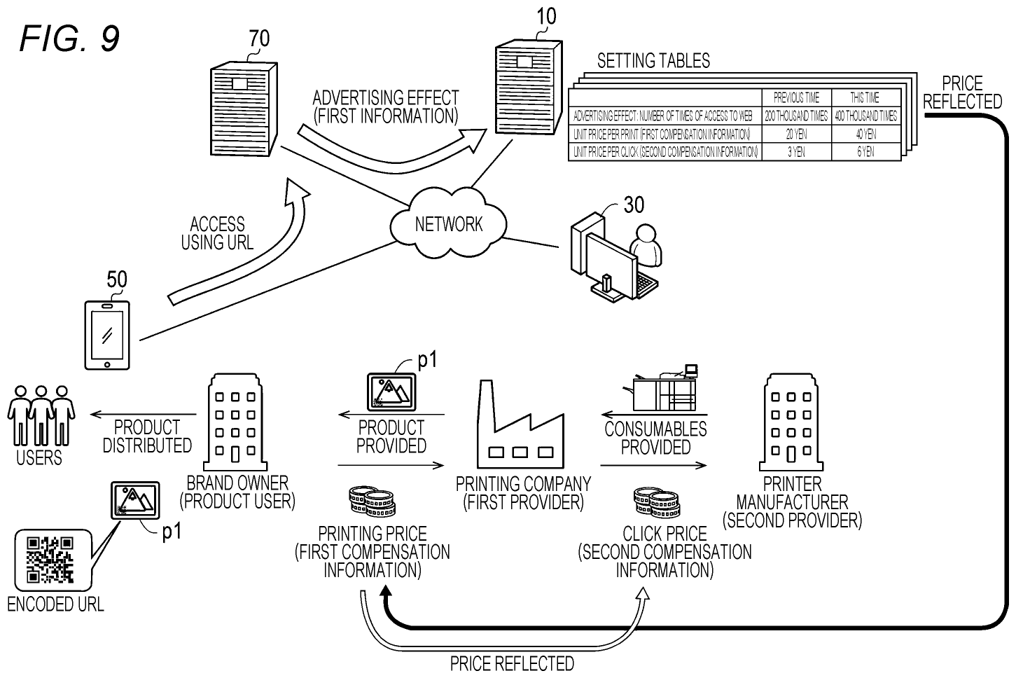

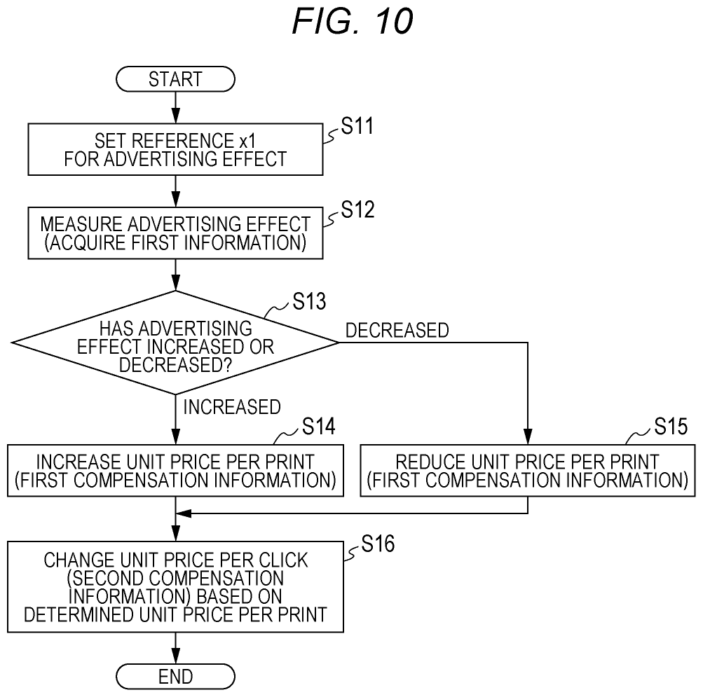

Next, an information processing system 10 according to a second embodiment will be described with reference to FIGS. 9 and 10. In the information processing system 10 according to the second embodiment, the configuration examples of the first embodiment illustrated in FIGS. 2 to 4 can be commonly applied.

FIG. 9 is a schematic diagram illustrating a situation in which a product, an advertisement, payment of compensation, and the like are handled in a market to which the information processing system 10 according to the second embodiment is applied. In FIG. 9, constituent entities such as a user, a brand owner, and a printing company, and processes are the same as those in FIG. 1, and a description thereof will be omitted. In the second embodiment illustrated in FIG. 9, unlike the embodiment illustrated in FIG. 1, a unit price per click (second compensation information) is not directly determined based on an advertising effect, but the unit price per click (second compensation information) is determined based on a unit price per print determined based on the advertising effect.

FIG. 10 is a flowchart illustrating a compensation determination process executed by the information processing system 10 according to the second embodiment. The process illustrated in FIG. 10 is partially common to the process illustrated in FIG. 7, and thus different points will be mainly described.

### Steps S11 to S13

Steps S11 to S13 are the same processing as steps S01 to S03 illustrated in FIG. 7. A reference setting section 112 sets a reference x1 for an advertising effect, and an acquirer 111 acquires first information as a result of measuring the advertising effect. Further, a controller 11 compares the first information with the reference x1, and determines whether or not the first information exceeds the reference x1.

### Steps S14 and S15

Here, a first determiner 113 performs processing similar to steps S04 and S05 illustrated in FIG. 7. To be specific, the first determiner 113 raises or lowers first compensation information in accordance with the result of the determination in step S13.

### Step S16

A second determiner 114 determines the unit price per click (second compensation information) based on a unit price per print (first compensation information) determined by the first determiner 113 in step S14 or step S15. In this case, the second determiner 114 refers to a setting table stored in a storage section 12. Next, the second determiner 114 may determine the unit price per click based on the absolute value of the unit price per print determined in step S14 or S15, or may determine the unit price per click based on a change (increase, decrease, or no change) in the unit price per print determined in step S14 or S15.

For example, processing may be performed so as to obtain a similar result to that of the method c22 in FIG. 5. For example, as indicated by the method c22 in FIG. 5, when the reference x1 is exceeded, promotion and advertisement are activated, and the first compensation information is raised, an increase in the number of printed sheets is expected. In this case, the second determiner 114 lowers the second compensation information in response to the raising of the first compensation information.

As described above, the information processing system according to the second embodiment includes: the acquirer that acquires first information relating to an advertising effect of a product created by an image forming apparatus; the first determiner that determines, based on the first information, first compensation information relating to compensation to be paid by the product user that requests the creation of the product to the first provider that creates the product by the image forming apparatus; and the second determiner that determines, based on the determined first compensation information, second compensation information relating to compensation to be paid by the first provider to the second provider that provides a consumable to be used in the image forming apparatus. Thus, the same effects as those obtained in the first embodiment can be obtained.

The configuration of the information processing system 10 described above is merely a main configuration for describing the features of the embodiment, and is not limited to the above configuration, and can be modified in various ways within the scope of the claims. In addition, a configuration included in a general information processing apparatus is not excluded. For example, the determination and output section 115 may be omitted.

Furthermore, the respective embodiments may be applied in combination with each other. For example, the method 1 may be applied in the procedure illustrated in FIG. 7. Furthermore, in addition to the payment of the compensation, in a case where the advertising effect increases to be higher than the reference x1, an amount by which the advertising effect increases may be held as points and used for the next and subsequent payment of the compensation. For example, when the number of times of access as the advertising effect is 400,000 times and is larger than 200,000 times as the reference x1 by 200,000 times, 200,000 points (corresponding to 200,000 yen) are given to the brand owner as points corresponding to the difference of 200,000 times so that the points can be appropriated for the subsequent payment.

In addition, means and methods for performing the various processes in the information processing system 10 according to the above-described embodiments can be implemented by any of a dedicated hardware circuit and a programmed computer. The program described above may be provided by, for example, a computer-readable recording medium such as a USB memory or a digital versatile disc (DVD)-ROM, or may be provided online via a network such as the Internet. In this case, the program recorded on the computer-readable recording medium is usually transferred to and stored in a storage section such as a hard disk. In addition, the program may be provided as independent application software or may be incorporated into software of the apparatus as one function of the apparatus.

Although embodiments of the present invention have been described and illustrated in detail, the disclosed embodiments are made for purpose of illustration and example only and not limitation. The scope of the present invention should be interpreted by terms of the appended claims.

What is claimed is:

1. An information processing system comprising:
an acquirer that acquires first information relating to an advertising effect of a product created by an image forming apparatus;
a first determiner that determines, based on the first information, first compensation information relating to compensation to be paid by a product user that requests the creation of the product to a first provider that creates the product by the image forming apparatus; and
a second determiner that determines, based on the first information, second compensation information relating to compensation to be paid by the first provider to a second provider that provides a consumable to be used in the image forming apparatus.

2. The information processing system according to claim 1, wherein
a URL is printed on the product, or a two-dimensional code obtained by encoding the URL is printed on the product, and
the first information relating to the advertising effect is calculated by measuring a number of times of access to a web page specified by the URL.

3. The information processing system according to claim 1, further comprising a reference setting section that sets a reference for the advertising effect, wherein
the first determiner and the second determiner respectively change the first compensation information and the second compensation information according to whether or not the first information is equal to or greater than the reference.

4. The information processing system according to claim 3, wherein when the product on which the same advertisement content as advertisement content printed on a product in the past is printed is to be created, the reference for the advertising effect is an advertising effect of the product in the past.

5. The information processing system according to claim 3, wherein the reference for the advertising effect is set based on a past history of corresponding advertisement content.

6. The information processing system according to claim 5, wherein the reference is set based on a standard advertising effect that is set based on a business size of the product user that is an advertiser and merchandise to be advertised as advertisement content.

7. The information processing system according to claim 3, wherein the reference for the advertising effect is set based on advertisement means for the product.

8. The information processing system according to claim 3, wherein in a case where an advertisement having the same advertisement content as advertisement content of the product is provided by another advertisement medium other than the product, the reference for the advertising effect is set based on an advertising effect provided by the other advertisement medium.

9. The information processing system according to claim 3, wherein
the first determiner raises the first compensation information and the second determiner raises the second compensation information when the first information relating to the advertising effect exceeds the reference, and
the first determiner lowers the first compensation information and the second determiner lowers the second compensation information when the first information relating to the advertising effect falls below the reference.

10. The information processing system according to claim 3, wherein
the first determiner raises the first compensation information and the second determiner lowers the second compensation information when the first information relating to the advertising effect exceeds the reference, and
the first determiner lowers the first compensation information and the second determiner raises the second compensation information when the first information relating to the advertising effect falls below the reference.

11. The information processing system according to claim 3, wherein
the first determiner lowers the first compensation information and the second determiner lowers the second compensation information when the first information relating to the advertising effect exceeds the reference, and
the first determiner raises the first compensation information and the second determiner raises the second compensation information when the first information relating to the advertising effect falls below the reference.

12. The information processing system according to claim 1, wherein in a case where products of same advertisement content are created in a plurality of lots, the first compensation information and the second compensation information determined in a previous lot are reflected in creating the product in a next lot.

13. The information processing system according to claim 1, wherein the first compensation information and the second compensation information are determined based on the first information after a predetermined period has elapsed since the product was created.

14. The information processing system according to claim 1, wherein the product user can appropriate a point when paying compensation to the first provider that creates the product, and the point corresponding to the first information relating to the advertising effect is given to the product user.

15. The information processing system according to claim 1, further comprising a storage section that stores a setting table in which the first compensation information and the second compensation information are set based on the first information relating to the advertising effect, wherein the setting table can be set by any one of the product user, the first provider, and the second provider, or the setting table stored in the storage section stores a plurality of setting tables having different values, and any one of the setting tables can be selected by any one of the product user, the first provider, and the second provider.

16. The information processing system according to claim 1, wherein
the acquirer acquires second information relating to an advertisement when a product for advertisement is to be printed,
the information processing system further comprising:
a determiner that determines, based on the acquired second information, whether or not the product to be created by an image forming apparatus is to be created as a product of which an advertising effect of the advertisement can be measured; and
an output section that outputs a result of the determination,
wherein the acquirer acquires, based on the result of the determination, the first information relating to the advertising effect of the product created by the image forming apparatus as the product of which the advertising effect of the advertisement can be measured.

17. A compensation determination method comprising:
(a) acquiring first information relating to an advertising effect of a product created by an image forming apparatus;
(b) determining, based on the first information, first compensation information relating to compensation to be paid by a product user that requests the creation of the product to a first provider that creates the product by the image forming apparatus; and
(c) determining, based on the first information, second compensation information relating to compensation to be paid by the first provider to a second provider that provides a consumable to be used in the image forming apparatus.

18. A computer-readable recording medium storing a control program for causing a computer to execute a process, the process comprising:
(a) acquiring first information relating to an advertising effect of a product created by an image forming apparatus;
(b) determining, based on the first information, first compensation information relating to compensation to be paid by a product user that requests the creation of the product to a first provider that creates the product by the image forming apparatus; and
(c) determining, based on the first information, second compensation information relating to compensation to be paid by the first provider to a second provider that provides a consumable to be used in the image forming apparatus.
